(19) United States
(12) Patent Application Publication
(10) Pub. No.: US 2005/0038697 A1
(43) Pub. Date: Feb. 17, 2005

(54) Automatically facilitated marketing and provision of electronic services

(76) Inventor: Jeffrey A. Aaron, Atlanta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/611,630

(22) Filed: Jun. 30, 2003

(51) Int. Cl. G06F 17/60

(52) U.S. Cl. 705/14; 705/26

(57) ABSTRACT

Systems for automatically facilitated marketing and provision of electronic services include a cycler configured to search through a plurality of databases to match user input with sales information in the databases and to provide keywords resulting from the search. An analyzer is operatively coupled to the cycler and configured to provide a set of potential services to be sold to a customer based on the keywords obtained from the cycler. Other systems and methods are also provided.

### TECHNICAL FIELD

The present invention is generally related to computer systems and, more particularly, is related to providing assistance in the sales process regarding security products.

### BACKGROUND OF THE INVENTION

Electronic security services such as anti-virus protection, hacker intrusion detection, electronic privacy protection, and firewalls are often technically complicated and difficult for customers to understand. Due to this complexity, the need for such services is also difficult to explain, demonstrate and sell to customers. Consequently, customers often do not choose to purchase such services, resulting in potentially dangerous and undesirable exposure of those customers to harm by electronic means, such as hacking, viruses, private or financial information theft, etc. Providers of electronic security services may wish to avoid placing customers in such dangerous circumstances, however, they are hampered by the difficulties encountered in selling protections that appropriately match the customers system configuration.

Thus, heretofore-unaddressed needs exist for a solution that addresses the aforementioned deficiencies and inadequacies.

### SUMMARY OF THE INVENTION

Preferred embodiments of the present invention provide a system and method for automatically facilitated marketing and provision of electronic services.

Briefly described, in architecture, one embodiment of the system, among others, can be implemented to include a cycler configured to search through a plurality of databases to match user input with sales information in the databases and to provide keywords resulting from the search. A service suggestion analyzer is operatively coupled to the cycler. The service suggestion analyzer is configured to provide a set of potential services to be sold to a customer based on the keywords obtained from the cycler.

Preferred embodiments of the present invention can also be viewed as providing methods for automatically facilitated marketing and provision of electronic services. In this regard, one embodiment of such a method, among others, can be broadly summarized by the following steps: searching a database for a match between user input and information in the database; obtaining keywords resulting from the searching step; utilizing a lookup table to associate the keywords with potential services to sell to a customer; and producing a set of suggested services and associated information regarding services that can be sold to the customer.

Other systems, methods, features, and advantages of the present invention will be or become apparent to one with skill in the art upon examination of the following drawings and detailed description. It is intended that all such additional systems, methods, features, and advantages be included within this description and be within the scope of the present invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram depicting a preferred embodiment of a system for automatically facilitated marketing and provision of needed electronic security services.

FIG. 2 is a block diagram depicting an illustrative example of a preferred embodiment of a system for providing automatically facilitated marketing and provision of needed electronic security services.

FIG. 3 is a block diagram of an illustrative example of a preferred embodiment of a service suggestion analyzer and an access filtering parser of a system for automatically facilitated marketing and provision of needed electronic security services.

FIG. 4 is a block diagram of an illustrative example of a preferred embodiment of a deep database structure of a system for automatically facilitated marketing and provision of needed electronic security services.

FIGS. 5A and 5B are flowcharts depicting functionality, in accordance with one preferred embodiment, of an implementation of automatically facilitated marketing and provision of needed electronic security services.

FIGS. 6A and 6B are flowcharts depicting functionality, in accordance with one preferred embodiment, of an implementation of identifying keywords for utilization by an automatically facilitated marketing and provision of needed electronic security services system.

FIG. 7 is an illustrative example of a preferred embodiment of cycling through a database structure of a system for automatically facilitated marketing and provision of needed electronic security services to obtain vulnerability information and/or information for selling security services.

### DETAILED DESCRIPTION OF THE PREFERRED EMBODIMENTS

Disclosed herein are systems and methods for automatically facilitated marketing and provision of needed electronic security services. To facilitate description, an example system that can be used to implement automatically facilitated marketing and provision of needed electronic security services is discussed with reference to the figures. Although this system is described in detail, it will be appreciated that this system is provided for purposes of illustration only and that various modifications are feasible without departing from the inventive concept. After the example system has been described, an example of operation of the system will be provided to explain the manner in which the system can be used to provide for automatically facilitated marketing and provision of needed electronic security services.

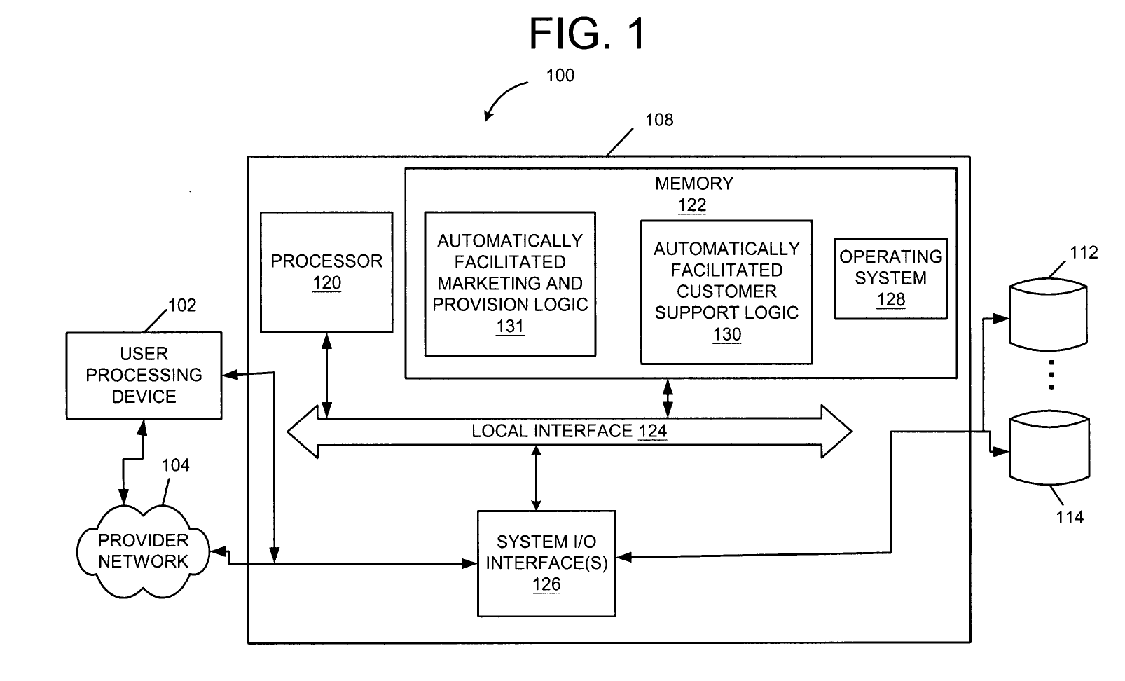

Referring now in more detail to the drawings, in which like numerals indicate corresponding parts throughout the several views, FIG. 1 is a block diagram depicting a preferred embodiment of a system 100 for automatically facilitated marketing and provision of needed electronic security services. The system 100 includes a user processing device 102, a provider network 104, a computing device 108 that depicts an illustrative example of an implementation of automatically facilitated marketing and provision of needed electronic security services that includes logic configured to provide for automatically facilitated customer support 130 and logic configured to provide for automatically facilitated marketing and provision 131, and a plurality of databases 112, 114. In one preferred embodiment, information stored in databases 112, 114 is organized as field, records, or files, etc. In another preferred embodiment, the databases 112, 114 are accessible to the digital computer 108 via the a system I/O interface 126. In yet another preferred embodiment, the digital computer 108 is configured to include the databases 112, 114 in memory. In still another preferred embodiment, the databases reside on a storage server (not shown) accessible by the digital computer 108.

The provider network 104 may be any type of communications network employing any network topology, transmission medium, or network protocol. For example, such a network may be any public or private packet-switched or other data network, including the Internet, circuit-switched network, such as a public switch telecommunications network (PSTN), wireless network, or any other desired communications infrastructure and/or combination of infrastructure. In an alternative preferred embodiment, the user interacts directly with the computing device 108.

Generally, in terms of hardware architecture, as shown in FIG. 1, the digital computer 108 includes, inter alia, a processor 120 and memory 122. Input and/or output (I/O) devices (or peripherals) can be communicatively coupled to a local interface 124 via a system I/O interface 126, or directly connected to the local interface 124. The local interface 124 can be, for example but not limited to, one or more buses or other wired or wireless connections, as is known in the art. The local interface 124 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 120 is a hardware device for executing software, particularly that stored in memory 122. The processor 120 can be any custom made or commercially available processor, a central processing unit (CPU), an auxiliary processor among several processors, a semiconductor based microprocessor (in the form of a microchip or chip set), a macroprocessor, or generally any device for executing software instructions.

The memory 122 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 122 may incorporate electronic, magnetic, optical, and/or other types of storage media. Note that the memory 122 can have a distributed architecture, where various components are situated remote from one another, but can be accessed by the processor 120.

The software and/or firmware in memory 122 may include one or more separate programs, each of which comprises an ordered listing of executable instructions for implementing logical functions. In the example of FIG. 1, the software in the memory 122 can include automatically facilitated customer support logic 130, automatically facilitated marketing and provision logic 131, and a suitable operating system (O/S) 128. The operating system essentially controls the execution of other computer programs, and provides scheduling, input-output control, file and data management, memory management, and communication control and related services.

Logic 130, 131 is preferably a source program, executable program (object code), script, or any other entity comprising a set of instructions to be performed. When the logic 130, 131 is implemented as a source program, then the program needs to be translated via a compiler, assembler, interpreter, or the like, which may or may not be included within the memory 122, so as to operate properly in connection with the O/S. Furthermore, logic 130, 131 can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices may include input devices, for example but not limited to, a keyboard, mouse, scanner, microphone, etc. Furthermore, the I/O devices may also include output devices, for example but not limited to, a printer, display, etc. The I/O devices may further include devices that communicate both inputs and outputs, for instance but not limited to, a modulator/demodulator (modem; for accessing another device, system, or network), a radio frequency (RF) or other transceiver, a telephonic interface, a bridge, a router, etc. Finally, I/O 126 may couple to the provider network 104 that is configured to communicate with the user processing device 102.

When logic 130, 131 is implemented in software, as is shown in FIG. 1, it should be noted that logic 130, 131 can be stored on any computer-readable medium for use by or in connection with any computer related system or method. Logic 130, 131 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where logic 130, 131 is implemented in hardware, the logic 130, 131 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

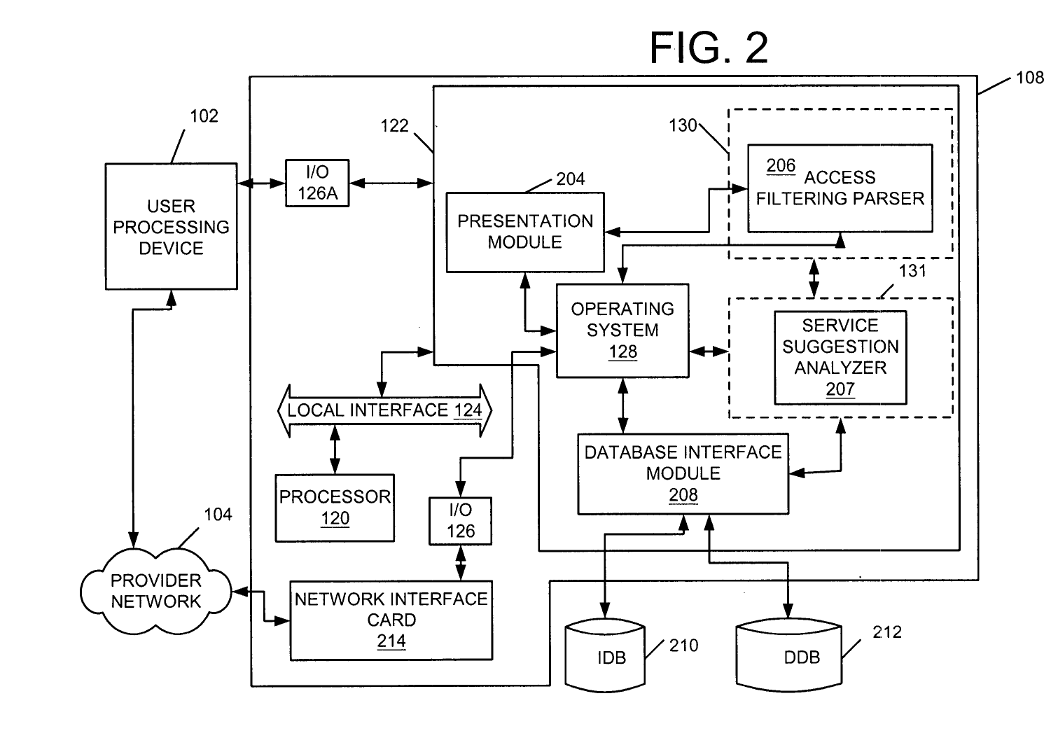

FIG. 2 is a block diagram depicting a more detailed illustrative example of a preferred embodiment of a system for automatically facilitated marketing and provision of needed electronic security services. The system includes the computing device 108 that communicates with the user processing device 102, provider network 104, databases 112, 114 configured as an index database (IDB) 210 and a deep database (DDB) 212. The computing device 108 further includes memory 122 having operating system 128 and logic 130 configured as an access filtering parser 206, logic 131 configured as a service suggestion analyzer 207, database interface module 208, and presentation module 204. Further computing device 108 includes local interface 124, processor 120, network interface card 214 and system interfaces 126, 126A. In an example, the user processing device 102 communicates with the computing device 108 via the I/O 126A. In another preferred embodiment, the user processing device 102 communicates with the computing device 108 via the provider network 104. In a preferred embodiment, the network interface card 214, I/O 126, and database interface modules 208 are utilized for communicating between the provider network 104 and the databases 210, 212.

The access filtering parser module (AFP) 206 provides an interface and algorithmic intelligence between the user processing device 102 and the databases 210, 212. On the interface “front end” the AFP 206 facilitates the interaction of user support requests with the system. For example, a request can embody a user support request document that it includes the information needed, especially any information from common security mechanisms available on systems managed by the user, such as firewall logs and anti-virus logs or results, among others. These mechanisms may include a special transmit-to-provider feature/option to automatically send information to the AFP 206 when problems are encountered. In a preferred embodiment, input is parsed or interpreted in order to match lists of keywords to items usable as input. The AFP “back end” algorithms collect state information via information presented and questions presented, accumulating descriptive information relevant to the user support request as well as associated circumstances and conditions, thereby allowing progression deeper into the databases 210, 212. In one preferred embodiment, the user can delve deeper into the databases 210, 212 by providing additional details and responding to questions pulled from the databases 210, 212. The answer to a particular question, for instance, could cause the inquiry to branch or be focused in a different direction or alternatively might provide the information needed to exclude or include a possibility, which may need to be considered by the user.

In a preferred embodiment, the service suggestion analyzer 207 is utilized to determine which services should be offered and possibly sold to a user or customer. Preferably, the service suggestion analyzer 207 is configured to interface with the access filtering parser 206 as well as via the database interface module 208 the IDB 210 and DDB 212.

In a preferred embodiment, the presentation module 204 summarizes and formats the accumulated results from a search in an appropriate manner to be informative to a user. In one preferred embodiment, the presentation module 204 utilizes software engineering to accomplish the presentation of results to the user. For example, application programming interfaces can be utilized that are consistent with the user's operating system such as Unix, Linux, Windows, etc., with specific configurations being dependent upon the particular implementation. In another preferred embodiment, the presentation module 204 includes functionality to eliminate repetitious information in the results stored from each cycle, for instance, by searching within the information for identical material and deleting subsequent occurrences so that the final results presented to the user do not exhibit any redundancies.

The database interface module 208 provides standard functionality utilizing, for instance, a structured query language to enable provisioning and access of the databases, IDB 210 and DDB 212. In an alternative preferred embodiment, an additional interface, such as a provisioning interface can be provided which provides for provisioning of the databases.

In a preferred embodiment, the DDB 212 is pre-provisioned such that modules of preferred embodiments of the invention can achieve the correct results. Preferably, data in the DDB 212 is arranged as a hierarchical structure of a plurality of database pages. The DDB 212 is preferably organized in a database structure of DDB pages 212 as a range of information or as a continuum into a set of discrete stages that conveniently allow for repeated input, via the sort of questions that an expert would typically ask at each stage. In an embodiment, the DDB 212 includes information used as an aid in selecting and selling security and security-related services, data storage, data backup, entertainment, among others. In an alternative preferred embodiment, the DDB 212 includes information for solving security related problems. In still other embodiments, the DDB 212 includes information for solving problems and for selecting and selling security related services.

For example, a top section of the DDB structure includes information necessary to answer broad or general questions and/or symptoms that would naturally occur with customer inquiries. An inquiry to a bottom section of the DDB structure results in specific helpful information that (i) answers the inquiry and/or (ii) provides specific advice for remedial action or selecting or selling a security service. Intermediate sections of the DDB structure are preferably pre-provisioned with information and prompting questions that leads the user from a top DDB page to the desired bottom page(s), and allows for branching to related DDB pages as needed to identify all associated helpful information.

In a preferred embodiment, the IDB 210 includes customer records and any other pertinent customer information.

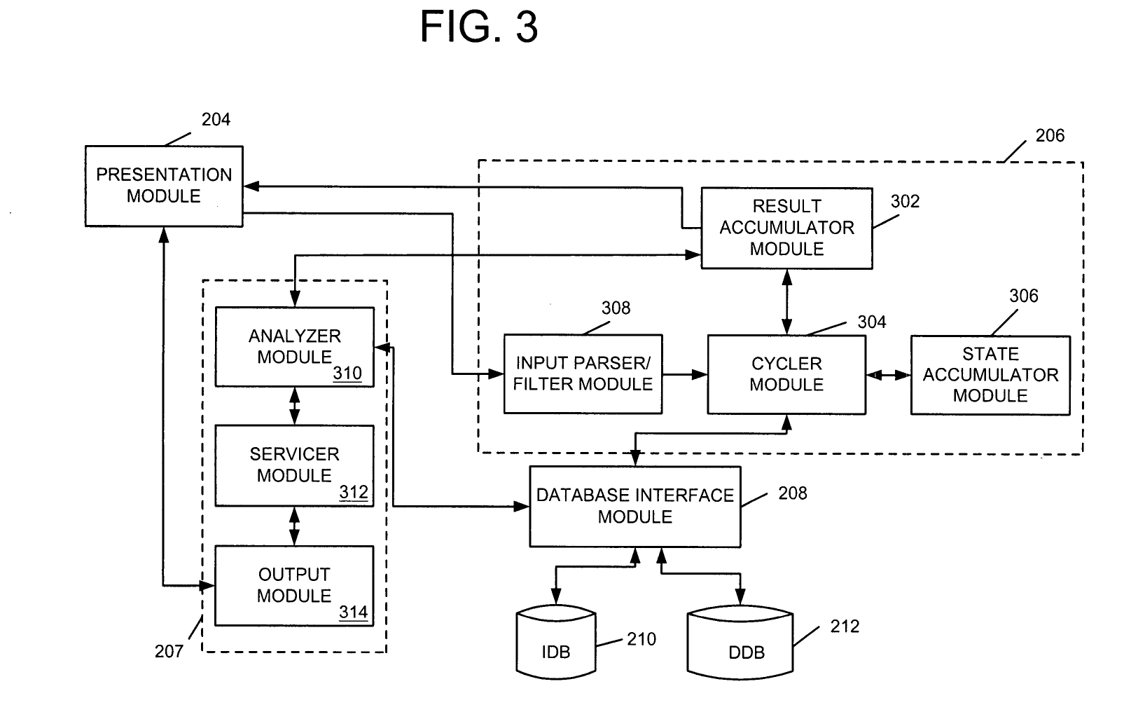

FIG. 3 is a block diagram of an illustrative example of a preferred embodiment of a service suggestion analyzer 207 and an access filtering parser 206 of a system for automatically facilitated marketing and provision of needed electronic security services. In a preferred embodiment, the access filtering parser 206 includes a result accumulator module 302 that couples to the presentation module 204 and a cycler module 304, a state accumulator module 306 that couples to the cycler module 304, and an input parser/filter module 308 that couples to the cycler module 304, presentation module 204 and couples to the user processing device 102 indirectly through the presentation module 204.

The input parser/filter module 308 receives input from the user's processing device 102 in a plurality of formats, such as email, web form, automatically generated files, for example, firewall or intrusion detection system logs, electronic interactive form input filled out by a customer representative talking to a customer, or input in response to prompting from a presentation module, among others. The input parser/filter module 308 converts the input to data usable by the cycler module 304. In one preferred embodiment, the input parser/filter module 308 utilizes standard software engineer techniques to convert the input into usable data. The input parser/filter module 308 preferably interacts with the user's processing device 102 via application programming interfaces that are consistent with the user's operating system, for instance, Unix, Linux, windows, etc., with the details of the interfaces being dependent upon the specific implementation including the choice of software language and design. In a preferred embodiment, the implementation is selected to perform the specific conversions needed for each allowed input type. During the conversion process, the input parser/filter module 308 filters out extraneous data, such that only pertinent input remains. Further, the input parser/filter module 308 receives keyword information from the presentation module 204 regarding any current prompting provided to the user so that user responses to that prompting can be associated with those pertinent keywords.

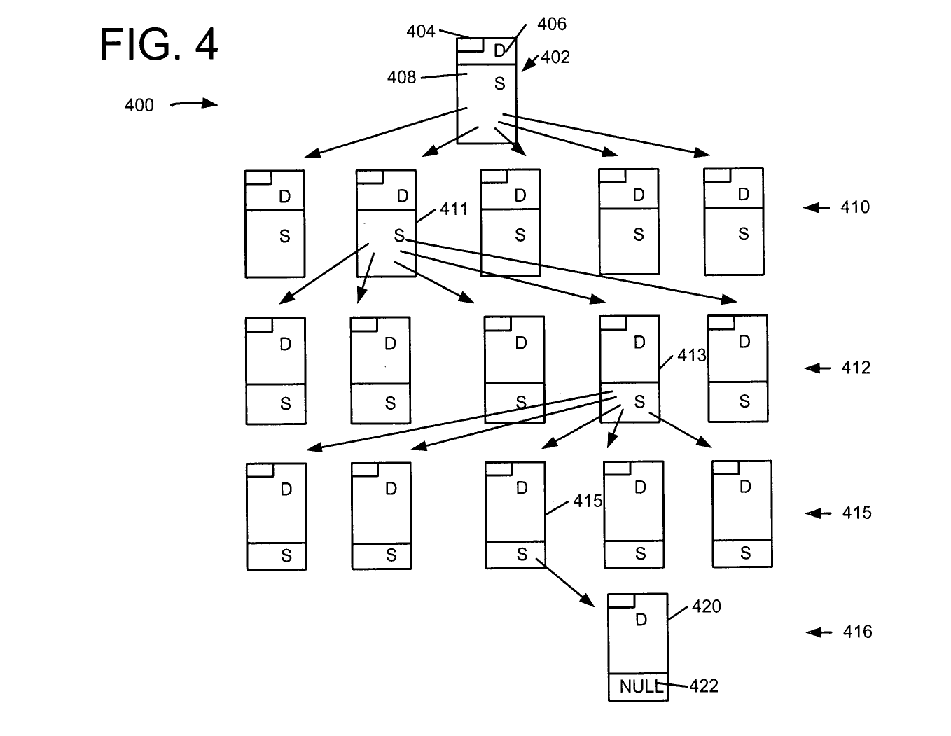

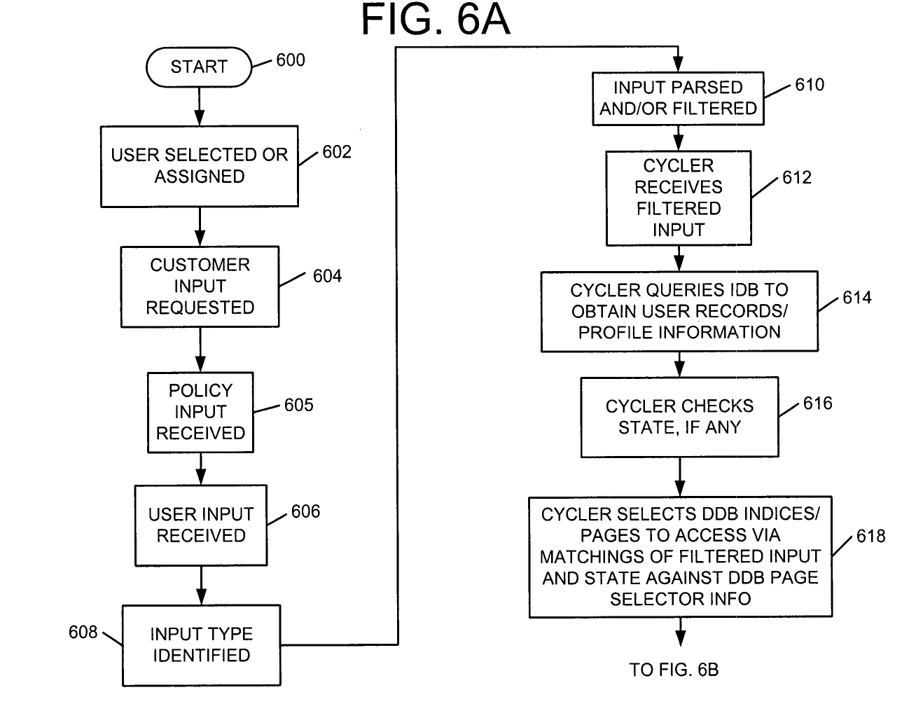

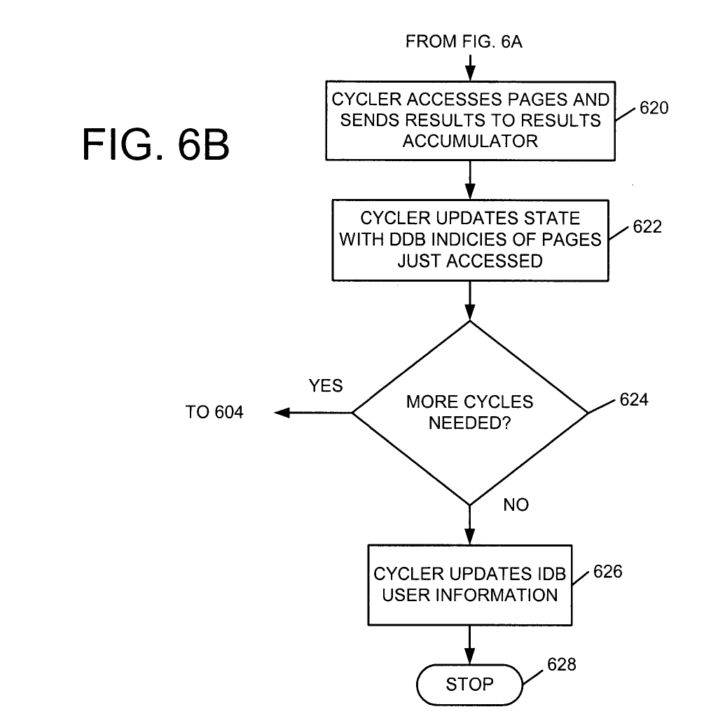

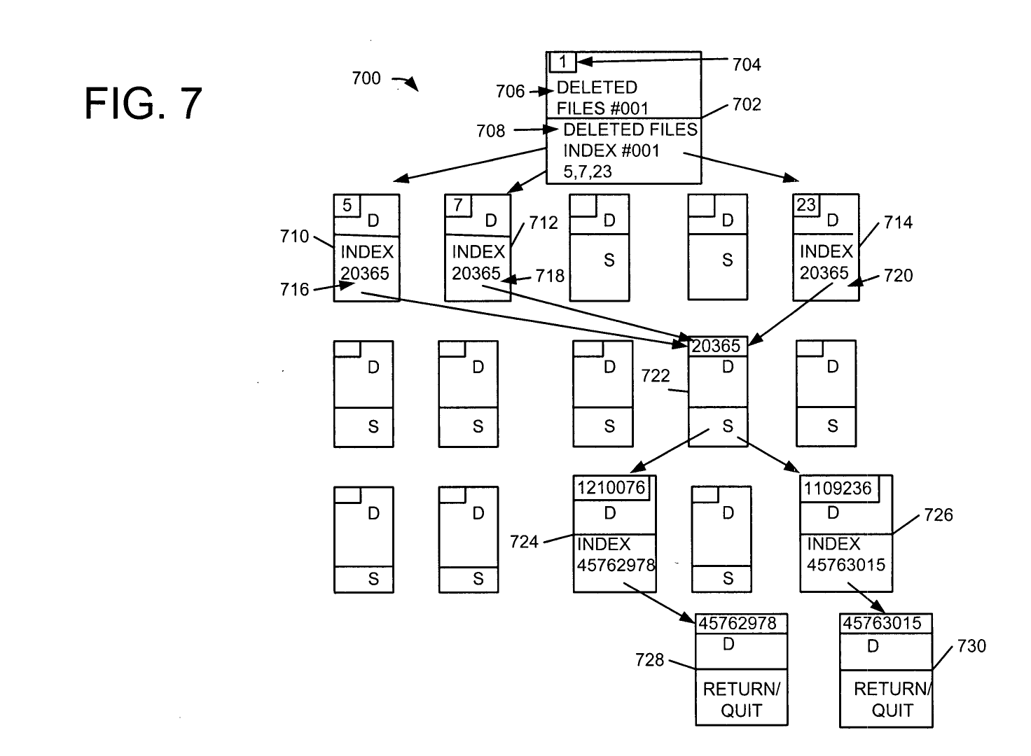

The cycler module 304 effects cycling through the process shown in FIGS. 6A, 6B, and 7 by gathering additional result detail until a satisfactory result is obtained. Intermediate and final result information is accumulated and/or stored in the result accumulator module 302. The cycler module 304 receives input from the input parser/filter module 308. The cycler module 304 queries the IDB 210 to obtain pertinent user records and associated information. Subsequently, the cycler module 304 checks the “state” in the state accumulator module 406. A state is comprised of summary and/or special information obtained from the DDB 212 in previous cycles, or obtained from the IDB 210, for the purpose of potentially aiding or modifying subsequent keyword matching/filtering. The cycler module 304 then selects the DDB indices/pages (shown in FIG. 4) to access via keyword matching between (a) the filtered input along with any “special state” information, if any, and (b) the information contained in the DDB page selector (shown in FIG. 4). Upon accessing the selected DDB pages, the cycler module 304 sends the pertinent information (e.g., data section) from these pages to the result accumulator module 302, retains the new selector information (e.g., selector section) and updates the “state” in the state accumulator module 306 as appropriate for example by adding the DDB indices of pages just accessed. In addition, the cycler module 304 either loops back to obtain additional user input or finishes by updating the user information in the IDB 210 with the cycle counter value (for example, indicating the depth/extent of the process just concluded) and the final resolution (for example, the list of pages/indices accessed to provide the final accumulated results).

The state accumulator module 306 stores intermediate status and result information that provides for keeping track of progress and for appropriately selecting the subsequent database accesses for each cycle of additional user input and database access/result determination. The state accumulator module 306 stores both the list of pages (via indices) accessed and any special state information. In an example, state information provides a mechanism for adding in or subtracting from the matching process for a specified keyword, in a circumstance where matching is not all or none but rather is by degree where the matching must for example exceed a pre-specified threshold in order to qualify as a match. In one preferred embodiment, the state accumulator module 306 provides a short-term memory that is utilized until the set of cycles associated with one user inquiry or problem is completed and the final accumulated results are presented to the user. At the conclusion of this set of cycles, the state is reset, or alternatively, the state is reset at the start of the next set of cycles.

The result accumulator module 302 stores intermediate results. The results of each cycle of additional user input and database access/result determination are added to the result accumulator module 302. At the end of the set of cycles associated with one user inquiry or problem, the result accumulator module 302 contains results for each cycle and makes these results available to the user's processing device 102 via the presentation module 204.

In an example, the service suggestion analyzer module 207 includes an analyzer module 310, servicer module 312 and output module 314. In an alternative preferred embodiment, the service suggestion analyzer module 207 also includes a psychological assistant module (not shown) and a special deals interface modules (not shown).

In a preferred embodiment, the analyzer module 310 obtains input from both the IDB 210 (via the database interface 208) and the results accumulator 302 and produces a prioritized and clustered needs list, composed of generic services that are defined in a conceptual or theoretical fashion rather than by reference to a specific service offered by the service provider(s). Technical decision weightings can be incorporated into the DDB 212 and arranged to be available to the analyzer module 310 from the result accumulator module 302. Prioritization is accomplished in the analyzer module 310 directly or indirectly (via algorithmic treatment) using these technical weightings (e.g., in the simplest case, higher weightings indicate higher priority for that particular prospective customer). Preferably, the analyzer module 310 maintains a lookup table of services that are indicated by particular keywords and combination of keywords. Clustering is accomplished in the analyzer module 310 via the lookup table that categorizes the generic services in the needs list.

In a preferred embodiment, the servicer module 312 obtains the needs list (of generic services) produced by the analyzer module 310, and from this list and a stored set of descriptions of actual available services offered by the service provider(s), produces a set of suggested services (ranked and explained/described). The servicer module 312 incorporates stored decision preference weightings per actual available offered service and service bundle (i.e., grouping of services offered as one purchasable entity), allowing suggestions to be skewed toward those preferred by a service provider. These, together with the technical decision weightings included in the needs list, can be utilized in a weighted summation (with associated methods, checks, and processes) to produce the best set of suggested services consistent with technical priorities/needs and sales provider preferences, ranked in order of desirability. The threshold checks and associated methods or processes can ensure that mere service provider preferences do not obtain unacceptable levels of influence on the final output. Once the summation scores are obtain and finalized, comparison scores are calculated via a normalization process to take bundles of multiple services into account, which may be more valuable/desirable than individual services since they contain more than one service.

In a preferred embodiment, the output module 314 provides the suggested services and sales aid information to the user (or operator, salesperson, etc.). In an example, the information is presented to the user via summaries and the output module 314 formats the accumulated results from a search in an appropriate manner to be informative to a user. Preferably, the information is presented with the suggested services and sales aid information segregated in some fashion, e.g. by separate window or highlighting, from other information displayed on a display of the user's processing device 102. In an alternative embodiment, the information can be presented to the user utilizing for instance, auditory means including synthesized voice, email, pager/paging, or just a different computer display, among others. Suggestions and sales aid information can be provided to the user at whatever stage of the process is desirable, for instance at the end of each cycle or at the end of all the cycles. In an example, the output module 314 couples to the presentation module 204 that summarizes result information that is displayed at a display of the user's processing device 102. In an alternative preferred embodiment, the output module 314 couples directly to the user's processing device 102.

In an alternative preferred embodiment, the service suggestion analyzer 207 includes a psychological assistant module (not shown). The psychological assistant module takes the suggested services output from the servicer module 312 and provides sales aid information to the user/salesperson via the output module 314. Alternatively, the psychological assistant module could act directly on the presentation module 204 to alter and augment the information the presentation module 204 provides to the user/salesperson. The psychological assistant module can incorporate into the information displayed to a user, sequences and scripts that are statistically known to elicit sales. The information can be divided into groups by user market segment, which for a given customer can be input by an administrator or can be determined by initial queries to the user.

In an alternative preferred embodiment, the service suggestion analyzer 207 includes a special deals interface (not shown). In a preferred embodiment, the special deals interface module interfaces with external systems (e.g. web or file servers) to obtain information related to special sales or time-sensitive offers. This information would be placed in a usable form and provided to the servicer module 312 for incorporation as appropriate. The special deals interface module can be coupled to external systems via the network interface card 214.

FIG. 4 is a block diagram of an illustrative example of a preferred embodiment of a deep database (DDB) structure 400 of a system for automatically facilitated marketing and provision of needed electronic security services. The DDB structure 400 includes a plurality of database pages 402. The database page 402 includes a page index 404, a data section 406 and a selector selection 408. The database pages 402 may also be referred to as entries or forms. The page index 404 preferably includes an index number and a descriptive title. In a preferred embodiment, the page index 404 is utilized by the DDB structure 400 to retrieve the appropriate database page 402.

In a preferred embodiment, the database pages 402 include technical weightings associated with keywords that the analyzer module 310 uses to determine potential generically-described services to be offered to the prospective customer. The analyzer module 310 maintains a lookup table of services that are indicated by particular keywords and combination of keywords. In some cases or embodiments, keywords (and keyword combinations) obtained will not have any associated services in the analyzer module's 310 lookup table. In other cases or embodiments, obtained keywords (and keyword combinations) may have multiple associated services in the table.

The data section 406 preferably includes the actual information and data accumulated and presented to the user regarding details of the identified vulnerability results and/or sales information regarding security related services. The selector section 408, encompasses in a preferred embodiment of one or more independent lines of data, includes up and down links to related database pages. In a preferred embodiment, the selector section 408 includes an index number as a database link to any related pages, and a matching field which contains a list of keywords, associated numeric ranges, etc., all of which can be used in the matching process to select subsequent pages to access. Thus, in a preferred embodiment, each independent line of the selector section contains one or more keywords plus one or more specific database page link indices with which these keywords are specifically associated as well as optional data such as related numeric ranges for alternate or advanced matching/filtering. In an alternative embodiment, the selector section 408 includes an empty or “null” downward-pointing indicator if the page is a “bottom page.”

In the illustrative example shown in FIG. 4, a cycle typically begins at the top database page 402. In an example, the database page 402 contains mostly selector section information. The database pages at level 410 include selector section 408 information, however the amount of solution data in the data section 406 is increasing. At level 412, the database pages include less selector section 408 information and more solution data in the data section 406. At level 414, the database pages include more detailed sales and/or solution data in the data section 406 and very little information in the selector section 408. Level 416 shows the bottom of the DDB structure for the illustrative example. Database page 420 includes a null section 422 indicating that this page is the bottom page. The bottom database page 420 does not include a downward pointing selector information and thus, a cycle stops at this page unless the cycle was previously stopped.

As shown in FIG. 4, the database pages are preferably organized in a hierarchical structure. For example, a cycle or search typically begins at DDB page 402. The selector section 408 of this page 402 provides links to a number of related pages. In an example, only one page, for example, DDB page 411 contains relevant information. Another cycle based on keywords identified in DDB page 411 uncovers links to the next level of DDB pages with DDB page 413 providing relevant information. Another cycle based on keywords identified in DDB page 413 reveals a link to DDB page 415. Another cycle based on keywords identified in DDB page 415 reveals a link to DDB page 420. In this example, DDB page 420 is the bottom page, as indicated by the null 422 reference, and thus no downward pointing selector information is available and the cycle ends.

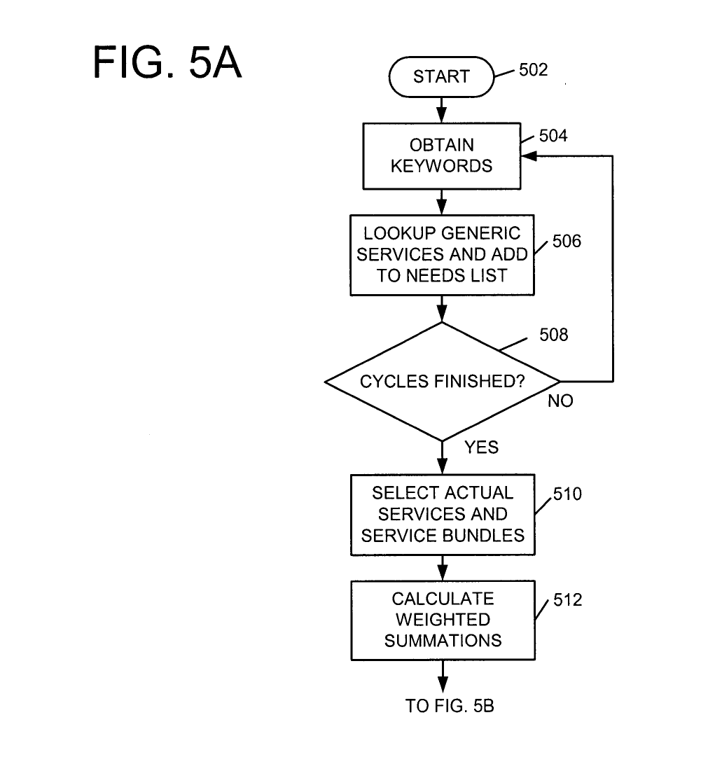

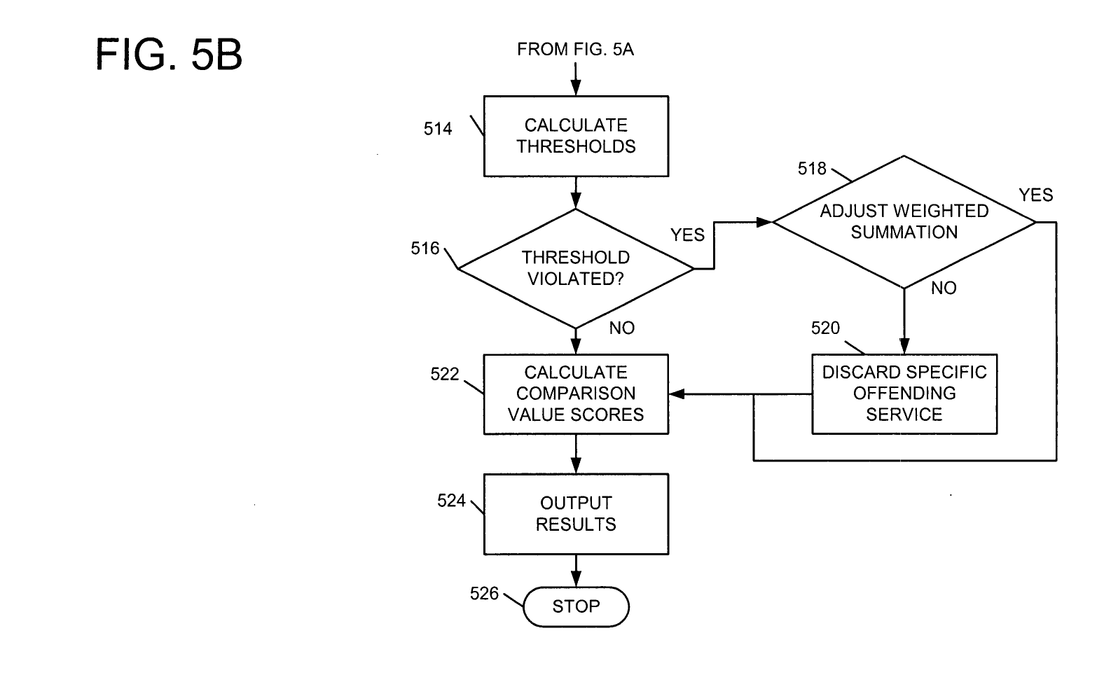

FIGS. 5A and 5B are flowcharts depicting general functionality (or method), in accordance with one preferred embodiment, of an implementation of automatically facilitated marketing and provision of needed electronic security services. The process begins at 502. At 504, keywords are obtained. In a preferred embodiment, an analyzer module obtains information and/or keywords from a cycler module or other searching device. In a preferred embodiment, the cycler module utilizes the process as shown in FIGS. 6A and 6B to obtain the keywords. At 506, the analyzer module looks in a lookup table or other storage mechanism to obtain generic services related to the keywords that can be sold to a customer and adds these generic services to a needs list. For example, virus-related keywords are associated with anti-virus services, worm-related keywords are associated with firewall services, keywords related to esoteric security problems are associated with intrusion detection services, etc. Additional specificity can be provided in cases where combinations of keywords can be used to compress the needs list. At 508, if the cycles are finished, at 510, services and bundles of services are selected from the database. If the cycles are not finished, additional keywords are obtained at 504. At 512, weighted summations are calculated. In an alternative preferred embodiment, a servicer module, psychological assistant module, and special deals interface module, produce suggested services and sales aid information, which is updated at the end of each cycle, via simple rules and calculations using the technical and preference weightings. The process continues on FIG. 5B.

Referring to FIG. 5B, at 514, thresholds are calculated. In an example, weighed summations and thresholds are calculated as follows. Preference data in the form of decision weightings per available offered service and service bundle are preferably provisioned into the servicer module. These weightings allow decisions to be skewed towards those preferred by the service provider, although they will not override the technical decision criteria unless those technical criteria are given very low weightings themselves. In this case, the system can prevent (via a settable “minimum technical weight” threshold setting) any undesired occurrence where a business criterion inappropriately outweighs technical criteria such that the customer could be sold an ineffective service. Technical security decision criteria obtained from the DDB structure has inherent weightings that are assigned prior to provisioning of the database by security experts. The weightings can then be adjusted mathematically in a preferred embodiment within the servicer module 312 via common normalization techniques such that they include a standard weighted summation with the business criteria and associated preference weights. Using an overall weighted sum approach to decision formation, final suggestions for services to be sold to a given customer are ranked such that they are presented, compared, and explained quickly and clearly by sales personnel or other user.

The preference weightings allow the results to be skewed as desired. In an example, the technical weights refer to weightings reflecting the inherent relative importance/value/utility of services from a technical point of view. The technical weights incorporate the judgment of technical experts in the technical area under which the offered services fall (e.g., security, for security related services). Thus technical weights do not represent preferences of the service provider, except in that the service provider will generally desire that the services offered be appropriately effective and useful to the prospective customer. Technical weights could be numbers between 1 and 100, with 100 being the most useful to the customer and 0 being of no use to the customer, as derived from the previous pre-provisioned judgments of experts in the technical area. Preference weights also could be numbers between 0 and 100, with 100 indicating that the service provider strongly favors a service while 0 indicated that the provider has no desire (currently) to sell that service. The service provider may have various business reasons for preferring to sell one service over another, which has nothing to do with the relative usefulness of those services to the customer. These business reasons are still valid, and should be taken into account, although they cannot be allowed to determine the outcome of the decision process that determines which services and service bundles to offer the customer. To accomplish this, the business preferences can be included into the decision process to an extent “acceptable” as determined by user.

The services suggested by the servicer module along with any preferred offers will be those with the highest total weighted sums of technical weights multiplied by preference weights, summed across all the component services which make up the suggested offering to the customer. If only one service is suggested, then its final score is simply its technical weight multiplied by its preference weight.

An example mathematical calculation is as follows: if, for the first service in a service bundle or group of offered services, the technical weight is referred to as T₁, and the preference weight is referred to as P₁, then a final score or weighted sum of 3 services comprising an offered service bundle would be calculated using a weighted summation, WS, of the following form, and would be a number between 0 and 100.
WS=1/3×[(T₁×(P₁/100))+(T₂×(P₂/100))+(T₃×(P₃/100))]

In this formula, each preference weight is normalized (by dividing by 100) to fall within a range of 0 to 1.0, which is then multiplied by the technical weights to form a number which falls between a range of 0 to 100. These three numbers are then added together to form a “pre-result” number which falls within the range of 0 to 300.The “pre-result” is then divided by 3 so that the final result always falls with the range of 0 to 100.

This formula can be generalized. For example, if the maximum number of services is N, then the 1/3 would be replaced by 1/N and there would be N terms to sum, rather than just three. In this way, a bundle or group of services can thus be considered to be any collection of one or more services, with the associated weighted summation, WS, calculated as above.

If five different service bundles are potentially appropriate for a prospective customer, the weighted summations for all five bundles can be calculated separately and then compared. The bundle with the highest summation value is chosen as the best to be offered to the customer. The bundles can also be ranked best-to-worst if desired, simply by being ordered via their final WS summation values in a highest-to-lowest fashion. Then, if the customer is offered the best choice but does not like it for some reason, they can be subsequently offered the next best choice, and so on until a bundle is found which the customer likes, and thus will purchase.

To ensure that technical and preference aspects of the WS final score meet minimum technical and business aspect requirements which might be decided upon, two check sums can be calculated, one for the technical weights alone and another for the preference weights alone.
TCS=Technical check summation=1/3×[(T₁)+(T₂)+(T₃)]
PCS=Preference check summation=1/3×[(P₁)+(P₂)+(P₃)]
Each of these represents the summation value, which will fall within the range of 0 to 100, that would have been obtained without the presence of the other aspect. Check thresholds can now be applied solely to the technical and preference aspects separately. For instance, if it is decided that technical check results should always be higher than a value of 30, then the technical aspects taken alone should result in a score of 30 to 100. A technical score lower than 30 would then cause this particular service bundle to be discarded (i.e., it would not be output, and so would not be offered to the prospective customer). This ensures that no service bundle is offered to any particular customer, which is of less utility than this threshold. In effect, this is a lower bound technical aspect limit.

In a similar fashion, a lower bound preference aspect limit could be assigned. For example, say a limit of 25 has been decided. This means that no bundles are offered to any particular customer which have a business preference aspect value of less than 25. This ensures that bundles with less business preference are discarded. This decision is preferably up to the service provider, and a lower bound preference aspect limit of 0 could be chosen so that no discards are ever made for this reason.

Additionally, business preferences should not overshadow technical weightings, because this could allow service bundles to be chosen and offered to customers which have been skewed too much from the fundamental technical aspects toward the business aspects/desires. This could cause the wrong services to be offered and sold, ultimately having significant negative impact on the service provider once these improper results are recognized (e.g., customers might sue the provider for resulting damages). Thus it is necessary to compare the technical aspect to the preference aspect, but not in terms of summations alone since this might mask the improper effects of one or more individual preference weightings. Thus, it is preferable to check that one or more terms in the weighted summation, individually or together, do not improperly contribute to the final result of the summation (i.e., do not result in an improper final WS score).

In an example, utilizing the basic WS formula for 3 services in the bundle with the 3 pertinent terms, the calculation is defined as follows:
Term 1=(T₁×(P₁/100))
Term 2=(T₂×(P₂/100))
Term 3=(T₃×(P₃/100))
To extend to N services, the Nth term would be:
Term N=(T_{N}×(P_{N}/100))

For a particular term, T can be low while P is very high. This is likely to cause the value of that term to be fairly high even though this is due more to a high business preference for the service represented by that term, rather than the technical merit (utility to the customer) of that service. Conversely, it is possible that, in a particular term, T can be high while P is very low. This is likely to cause the value of that term to be fairly low even though this is due more to a low business preference for the service represented by that term, rather than the technical merit i.e., utility to the customer, of that service. Such situations must be controlled and avoided because they may result in the final weighed summation value being improperly high (or conversely, low), and causing this service bundle to be chosen (or conversely, not chosen) over other potential service bundles to be offered to the prospective customer, even though it is due more to business preference than the technical merit of the offering.

An example of a check on the ratio of the technical and preference check summations as follows:
TCS/PCS=Overall ratio check=ORC
A term by term check of the ratio of the technical and preference weights as follows, where K is simply the number of the term in question and falls in the range of 0 to N:
T_{K}/P_{K}=Term ratio check=TRC_{K}
Minimum value thresholds can first be applied to the two ratios, namely:
Min_Threshold_{ORC} and Min_Threshold_{TRC}
For instance, if it decided that an ORC minimum value threshold of 1.75 is appropriate, then any service bundles for which the ORC is less than 1.75 are inappropriate because there is too much influence of business aspects over technical aspects. If it is decided that a TRC_{K} minimum value threshold of 1.33 is appropriate, then any service-related term in the weighted summation, WS, is inappropriate.

Once the thresholds are calculated, at 516, the servicer module determines whether the threshold has been violated. If yes, at 518, the weighted summation is adjusted. If it is not appropriate to adjust the weighted summation, at 520, the specific offending service is discarded. For example, if the overall weighed summation is deemed inappropriate due to the ORC falling below minimum threshold, then either the service bundle could be discarded entirely, or its weighted summation could be reduced to a certain extent in which case it is still in the list of bundles to be offered, but its rank within that list is reduced. Alternately, two ORC thresholds could be employed, one to cause the bundle's WS to be reduced if the ORC falls below it, and the other even-lower threshold to cause the bundle to be discarded entirely.

With respect to minimum threshold, the WS for an “inappropriate” ORC could be reduced in various ways, for example:
WS_{reduced}=WS_{original}×[1−(Min_Threshold_{ORC}−ORC)]
In this example, the WS is reduced in a linear fashion as the difference between the ORC and the threshold increases (i.e., as the actual ORC goes further and further below the threshold). Alternately, using other well-known mathematical approaches, the WS could be reduced in step-by-step fashion, exponential fashion, etc. The effect is to progressively “penalize” the bundle's WS final score as the actual ORC falls further below the decided-upon threshold. However, this is proper since the intent of this “penalization” is to correct for inappropriateness caused by business aspects having an overly large effect relative to the technical aspects.

In a similar way, any inappropriate term as found by the term by term ratio check could either be discarded removed from the WS calculation, with N being reduced by one for the sake of preserving the integrity of the calculation, or else the effect of the term on the final WS value could be reduced. Alternately, two term ratio thresholds could be employed, one to cause that term's effect on the final WS value to be reduced if the TRC_{K} falls below it, and the other even-lower threshold to cause the term to be discarded entirely (with N reduced by one in the WS calculation formula).

With respect to minimum threshold, the effect of an “inappropriate” term on the final WS value could be reduced in various ways, for example by reducing the value of the particular term as follows:
Term_{reduced}=Term_{original}×[1−(Min_Threshold_{TRC}−TRC_{K})]

In this approach, the term is reduced in a linear fashion as the difference between the TRC_{K} and the threshold increases (i.e., as the actual TRC_{K} goes further and further below the threshold). Alternately if desired, using other well-known mathematical approaches, the term could be reduced in step-by-step fashion, exponential fashion, etc. However reduced, the effect is to progressively “penalize” the bundle's WS final score as the actual TRC_{K} goes further and further below the decided-upon threshold. Furthermore, this term-derived WS “penalization” will become additively greater as additional terms fall below threshold. However, this is proper since the intent of this “penalization” is to correct for inappropriateness caused by business aspects having an overly large effect relative to the technical aspects.

Similarly, maximum value thresholds can also be applied to the two ratios, namely:
Max_Threshold_{ORC} and Max_Threshold_{TRC}
For instance, if it decided that an ORC maximum threshold of 8.25 is appropriate, then any service bundles for which the ORC is more than 8.25 are inappropriate (in the sense that there is too much influence of business aspects over technical aspects). If it is decided that a TRC_{K} maximum value threshold of 9.66 is appropriate, then any service-related term in the weighted summation, WS, is inappropriate.

If the overall weighed summation is deemed inappropriate due to the ORC falling above maximum threshold, then either the service bundle could be discarded entirely, or its weighted summation could be reduced to a certain extent (in which case it is still in the list of bundles to be offered, but its rank within that list is reduced). Alternately, two ORC maximum thresholds could be employed, one to cause the bundle's WS to be reduced if the ORC rises above it, and the other even-higher threshold to cause the bundle to be discarded entirely.

With respect to maximum threshold, the WS for an “inappropriate” ORC could be reduced in various ways, for example:
WS_{reduced}=WS_{original}×[1−(Max_Threshold_{ORC}−ORC)]

In this approach, the WS is reduced in a linear fashion as the difference between the ORC and the threshold increases (i.e., as the actual ORC goes further and further above the threshold). Alternatively, using other well-known mathematical approaches, the WS could be reduced in step-by-step fashion, exponential fashion, etc. However reduced, the effect is to progressively “penalize” the bundle's WS final score as the actual ORC rises further above the decided-upon threshold. However, this is proper since the intent of this “penalization” is to correct for inappropriateness caused by business aspects having an overly large effect relative to the technical aspects.

In a similar way, any inappropriate term (as found by the term by term ratio check) could either be discarded (i.e., removed from the WS calculation, with N being reduced by one for the sake of preserving the integrity of the calculation), or else the effect of the term on the final WS value could be reduced. Alternatively, two term ratio thresholds could be employed, one to cause that term's effect on the final WS value to be reduced if the TRC_{K} rises above it, and the other even-higher threshold to cause the term to be discarded entirely (with N reduced by one in the WS calculation formula).

With respect to maximum threshold, the effect of an “inappropriate” term on the final WS value could be reduced in various ways, for example by reducing the value of the particular term as follows:
Term_{reduced}=Term_{original}×[1−(Max_Threshold_{TRC}−TRC_{K})]
In this approach, the term is reduced in a linear fashion as the difference between the TRC_{K} and the threshold increases (i.e., as the actual TRC_{K} rises further and further above the threshold). Alternately if desired, using other well-known mathematical approaches, the term could be reduced in step-by-step fashion, exponential fashion, etc. Note that, however reduced, the effect is to progressively “penalize” the bundle's WS final score as the actual TRC_{K} rises further and further above the decided-upon threshold. Furthermore, this term-derived WS “penalization” will become additively greater as additional terms rise above threshold. However, this is proper since the intent of this “penalization” is to correct for inappropriateness caused by business aspects having an overly large effect relative to the technical aspects.

In an alternative preferred embodiment, mathematical methods and formulation could be used to implement preferred embodiment of the invention. The above-described embodiments are simply typical methods, formulae, and procedures provided for exemplary purposes. For example, an alternate means of controlling the impact of business preferences (relative to technical aspects) involves applying minimum and maximum limits to the preference weightings directly, so that they do not fall outside an “allowed” range that has been deemed acceptable. For example, an allowed range of 33 to 75 is chosen out of a theoretical maximum range of 0 to 100.

At 522, comparison value scores are calculated. In an example, after the servicer module has taken the list of potential generically-defined services from the analyzer module, it employs methods such as embodiments described above to generate an initial list of valid, appropriate services, either individually or as service bundles, which are rank ordered in terms of desirability once the appropriate threshold checks (or alternatively, range limits or other suitable methods) have been accomplished for each offering, and any necessary alteration of the WS scores are made. Then, if any service bundles are present in the list, the servicer module determines the number of component services comprising each bundle. The servicer module normalizes the WS scores to account for presence of bundles, which are inherently of greater value as more and more services are included within them. For example, normalizing the WS scores can be achieved by dividing the individual service WS scores by the maximum number of services in any bundle in the list, denoted by B. For all the bundles, their scores are multiplied by N/B, with N=1 for individual services to preserve the final range of scores between 0 and 100. Subsequently, the servicer module rank-orders the offerings in order of comparison value, CV:
CV=(N/B)×WS_{adjusted}
At 524, the results from the servicer module are sent to the output module for display. In a preferred embodiment, the results are output directly to a user's display coupled to the user's processing device. In an alternative preferred embodiment, the results are sent to a presentation module for use by the user's display coupled to the user's processing device. The process ends at 526.

FIGS. 6A and 6B are flowcharts depicting more specific functionality (or methods), in accordance with one preferred embodiment, of an implementation of identifying keywords for utilization by an automatically facilitated marketing and provision of needed electronic security services system. The process begins at 600. At 602, the user (or customer) is selected or assigned in order to identify the user so that the appropriate set of information contained in the IDB (which may contain information associated with many different users) can be appropriately selected and accessed. The cycle counter is set to 1. At 604, user input is requested. In a preferred embodiment, a user processing device configured to interact with a presentation module is utilized to query the user. At 606, the user input is received. User input can be received via a plurality of mechanisms, including input received directly from the user, email, web page form, or pager, or a combination of these inputs, among others. At 608, the type of input is identified. For instance, the input is identified as being manual, web form, log file, email, or a combination of these types of input, among others. At 610, the input is parsed and/or filtered such that only potentially useful information remains. At 612, in a preferred embodiment, a cycler module receives the filtered input. Preferably, the filtered input is provided in a format that is suitable for matching with data selector information of a database page of a deep database (DDB) structure. At 614, the cycler module queries an index database (IDB) to obtain user records (or profile) information. At 616, the cycler module checks for any “states” via the state accumulator module. The state is comprised of summary and/or special information obtained from the DDB in previous cycles, or obtained from the IDB, for the purpose of potentially aiding or modifying subsequent keyword matching/filtering. At 618, the cycler module selects the DDB indices and/or pages to access utilizing the matching of the filtered input and state information against the DDB page selector information. In a preferred embodiment, the cycler module begins at a top page of the DDB structure on the first cycle. A portion of each DDB page includes selector information that is matched against the next cycle. In a preferred embodiment, the cycler module performs matching to determine the next DDB page or pages to access by performing a matching between the filtered input plus any special state information, if any, and the information contained in the DDB page selector from the last DDB page or pages are accessed. In one preferred embodiment, these matches consist of whether keywords are present or not in both the filtered input and the currently-held page selector information. If simultaneously present, there is a match, and the associated page index or indices within that line of the page selector information provides the identification of subsequent pages to be accessed. In an alternative preferred embodiment, a more complex match “by degree” is also possible, utilizing “special state” information in the form of positive or negative numerical values which are combined with numerical values assigned to certain keywords to determine whether pre-set thresholds are exceeded. If exceeded, then there is a match, and the associated page index or indices within that line of the page selector information provide the identification of subsequent pages to be accessed. The special state information, assigned keyword numerical values, and the pre-set thresholds can be part of the data or selector areas on any DDB page, and if encountered are held in the state accumulator module until it is reset at the beginning of the next inquiry (set of cycles). When the special state information occurs in an early cycle, this causes an increased or decreased sensitivity to the occurrence of specified keywords that may be encountered in later cycles (within the same set of cycles), and provides additional flexibility in the matching process. In some embodiments, this is used to reflect cases where associations between input and results are of a probabilistic nature or imply a tendency towards something i.e., not direct and certain one-to-one associations.

In an alternative preferred embodiment, the special state information could be arranged to be “multiplicative” or “divisional” (or any other suitable mathematical process) in addition to, or rather than, being “additive” or “subtractive,” in which case the default keyword numerical value would be multiplied or divided by the “special state” numerical values before being applied to the threshold test. A single match can occur, or multiple matches can occur at the same step (cycle) of the process, where multiple matches represent the occurrence of multiple simultaneous conditions. The process continues on FIG. 6B.

Referring to FIG. 6B, at 620, the cycler module accesses the DDB selected pages and sends the results to a result accumulator module. At 622, the cycler module updates the state information in the state accumulator module with DDB indices of pages just accessed. At 624, a determination is made as to whether more cycles are needed to satisfy the customer's input request. In a preferred embodiment, the determination is made by a user who decides that more cycles are needed to obtain requested information. In an alternative preferred embodiment, the cycler module knowing that it has not yet reached the bottom DDB page makes the determination. If more cycles are needed, the cycle counter is incremented by one and preferably the process continues at 604 with the user providing additional input for each new cycle. Preferably, the state is accumulated as the cycles continue, and the process ends when the user is satisfied by selecting “finished” or provides a “no further cycles” notification. In an alternative preferred embodiment, the process ends when the cycling has occurred down to the bottom of the DDB structure, in which case the selector information contains no further possible page look-ups. If no more cycles are needed, at 626, the cycler module updates the IDB with customer information. Customer information can include, but is not limited to, cycle counter value and problem resolution data. The process ends at 628.

FIG. 7 is an illustrative example of a preferred embodiment of cycling through a database structure of a system for automatically facilitated marketing and provision of needed electronic security services to obtain vulnerability information or information for selling security services. In an example, the user requests help regarding a security problem involving a virus. In one preferred embodiment, the user (or customer) utilizes the implementations as shown in FIGS. 5, 6A and 6B. Typically, the process begins at the top level of the DDB structure 700 and gathers more detailed information with each cycle, gradually traversing down through lower levels of the DDB structure 700 as the user is repeatedly prompted for pertinent input. The DDB structure 700 includes a configuration that includes a plurality of DDB pages, such as DDB page 702. Using DDB page 702 as an example, each DDB page includes a page index 704, a data section 706 and a selector section 708. Any pointers and keywords shown in FIG. 7 are for illustrative purposes and during implementation, the prompts and keywords would be chosen and arranged by subject matter experts and experts in user interaction for effective cycling of the DDB structure 700.

In a preferred embodiment, initialization begins with any state previously stored in the state accumulator module 306 being reset (i.e., erased). The user is identified by accessing the IDB 210 to retrieve the pertinent user records. User records can include known configuration information, for instance, the user's operating system, software applications installed or used, level of help service purchased, etc. This information, or a subset of it, is stored in the state accumulator module 306 for reference. The cycle counter is reset to equal “1” which represents the first cycle. The analyzer module 310 and servicer module 312 are also initialized.

In an example, DDB page 702, is the first page of the DDB structure 700 with a page index=1 (704) and is the “current” page 702. The current page is arranged to list a number of symptoms that are presented to the user. In an illustrative example, page 702 includes the symptom, “files have disappeared even though they have not been purposely deleted.” The user selects this problem. If any extraneous input is provided by the user, the input parser/filter module 308 removes it. Associated with this chosen symptom is the keyword “Deleted_Files #001,” which is provided by the input parser/filter module 308 to the cycler module 304. The cycler module 304 examines the selector section 708 of the current page 702 (i.e., the top page) and detects that “Deleted Files #001 Index 5, 7, 23” is present as one of the lines of the selector information, indicating that pages 5, 7, and 23 should be accessed. The cycle counter is incremented to “2.”

The “Deleted_Files_{—}001” keyword is associated by the analyzer module 310 with two generic services, “Anti-Virus” and “Firewall,” both with technical weights of 70, which are added to the needs list. This is because deleted files may be a common symptom of virus action as well as worm action, with protection from viruses commonly being afforded by anti-virus methods (which seek out virus files) while protection from worms is commonly afforded by firewall mechanisms (which prevent the worms from transferring themselves over a network). It is unclear at this point whether the problem is from virus infection or from worm infection. The generic needs list that is maintained by the analyzer module now consists of “Anti-Virus” and “Firewall.”

DDB pages 5, 7, and 23 (710, 712 and 714, respectively) are accessed. Data section portions of each page 710, 712 and 714 are provided to the result accumulator module 302. The result accumulator module 302 stores the information from the data sections and provides the included prompt (also referred to as a pointer) related information, informative text and graphics to the user via the presentation module 304. Pages 5, 7, and 23 (710, 712 and 714) become the “current” pages. Upon reviewing the information, the user determines that pages 5 and 7 do not apply but page 23 does apply. The prompt from page 23 asks the user if he has anti-virus software available, and if so, what kind, and what were the results from using the anti-virus software, for instance, did the software detect a specific virus by name. The user has anti-virus software available, which indicated that the user has a specific virus. The user provides the appropriate input, including the virus name “JavascriptDream04W.” Keywords associated with these inputs (e.g., Antivirus=Yes, Norton_Version2000, and JavascriptDream04W) are provided to the cycler module 304, which looks for matches within the selector sections 716, 718 and 720 of pages 5, 7, and 23 (710, 712 and 714). A match is found which includes all three keywords. The index for the match is “Index 20365,” indicating that page 20365 should be accessed to obtain information on this particular virus. In an alternative preferred embodiment, if the user had anti-virus software but did not have a virus identified by name, keywords resulting from responses to the prompts would direct the cycler module 304 to access pages which would lead the user through the steps needed to obtain the virus name, or other associated details, for the user's specific anti-virus software. Indices 5, 7, and 23 are stored as “state” in the state accumulator module 406. The cycle counter is incremented and now it equals 3.

The three current pages are pages 5, 7, and 23. The user decides that only the information obtained from page 23 is pertinent. In alternative examples involving multiple current pages, a user may find pertinent information originating from all or some subset of those current pages.

The “JavascriptDream04W” keyword, both individually and in combination with the previous “Deleted_Files_{—}001” keyword, is associated by analyzer module 310 with the previously identified generic “Firewall” service as well as the more elaborate generic “Web-Content Firewall Filtering” service (technical weight of 90), which is now added to the needs list. Alternatively, the “JavascriptDream04W” keyword may be associated with the previously identified “Anti-Virus” service as well, since it may be classified as a virus depending on the terminology used. This is because Javascript “viruses” are usually obtained from web sites via browsing web pages where these viruses are attached to links on those pages, and when clicked on are transferred from the web page down to the user's computer, which they may then infect. To prevent this, filtering out of such transfers is desired. Although a general firewall is good and certainly appropriate for this customer since they are obviously connecting to unsafe networks (e.g., the Internet), and thus would definitely benefit from any type of firewall, a general firewall cannot specifically prevent this mode of infection. A more expensive web-content filtering type of firewall service is needed. Note that the generic needs list maintained by the analyzer module 310 now contains “Anti-Virus,” “Firewall,” and “Web-Content Firewall Filtering.”

The index from page 23 (714) is 20365. The user selects page 23, causing the cycler module to access page 20365 (722) and provide its data section to the result accumulator module 302. The presentation module 204 provides prompts and informative text and graphics to the user regarding information on page 20365 (722). A number of necessary questions are asked regarding the type of files lost. Likewise, other questions are asked for example, other pertinent software applications that may be installed. If such information is already in user information retrieved previously, and available in the state accumulator module 306, then certain questions regarding installed software questions are not asked or are asked in slightly different form (e.g., merely to verify rather than obtain additional needed details, such as the software version number). The user answers the questions, enabling the associated keywords to be provided to the cycler module 304, which finds a selector area line containing index references to pages 1109236 and 1210076 (726 and 724). Index 20365 is added to the state stored along with the previously stored information in the state accumulator module 306. The cycle counter is incremented to 4.

Pages 1109236 and 1210076 (726, 724) are accessed. Information from page 1109236 (726) leads the user through a set of actions to search for and delete certain files installed by the virus. Information from page 1210076 (724) leads the user through a set of actions to search for and remove a number of items added to the Windows™ registry. Prompts are presented to the user to indicate the completion of these actions and the results. When the user responds to the prompts, keywords are provided to the cycler module 304, which finds a line in the selector section of each page, one line including “Index 45762978” and the other including “Index 45763015.” Indices 1109236 and 1210076 are added to the state of the result accumulator module 302. The cycle counter is incremented to 5.

In this example, the cycler module 304 searched selector areas in two current pages for keyword matches, and found matches in both. In an alternative example, the cycler module 304 may find matches on only one of a number of current pages. In another alternative example, the cycler module 304 may not find a match. In this case a default match occurs via the last line of each selector area. For instance, a “return to higher level” entry with an index may be provided such that the system safely returns to a point where the user could be prompted for further input that subsequently would allow the system to continue to process. In some examples, the “return to higher level” entry occurs repeatedly due to for instance, repeated lack of matches, until the user returns to all the way back up to the top page, which by default would have an “exit”option (e.g., page 0 (not shown), to cause the system to return to its start-up condition). In addition, every page preferably includes an “exit” option as the second to last entry in the selector section, so that the user is always afforded the option to exit regardless of where the user is in the process.

The user accesses pages 45762978 and 45763015 (728, 730) and information from these pages is presented to the user. Page 45762978 (728) provides useful conclusions and information regarding the service or process just completed. Page 45762978 (728) may include information such as thanking the user for using the service, and request that the user to determine whether they wish to make another inquiry or quit. Page 45763015 (730) may also provide the user with the ads and related service offerings, including for instance, time-sensitive offers. The user elects to quit. The cycle counter is incremented to 6.

In an alternative preferred embodiment where the user quits the system, the accumulated state could be erased from the state accumulator module 306 at this point rather than left intact to be erased at the next initialization occurrence. If the user chose not to quit, the system would be returned to initialization step except that the user's records would not have to be pulled from the IDB 210 since that information is already present. Pages 45762978 and 45763015 (728, 730) are both “bottom” pages, in that they include no selector section information other than the “return to higher level” and/or “quit” entries, i.e., they contain no other lines of keywords with associated index values (other than these last two default lines for “return” and “quit”). Thus pages 728, 730 include null selectors, and cannot be utilized to delve to any deeper level of the DDB structure 700 since no deeper level of the DDB structure 700 exists for this example inquiry.

The servicer module 312 obtains the needs list from the analyzer module 310 (i.e., the list of the three generic services “Anti-Virus,” “Firewall,” and “Web-Content Firewall Filtering”), and initially selects five actual service offerings that could reasonably be offered to the customer based on the list of generic needs. The first actual service appropriate for consideration is an Anti-Virus service. The second is a Basic Firewall service. The third is a Web-Content Filtering Firewall service. The fourth is a bundle of two services, specifically the Anti-Virus service and the Basic Firewall service. The fifth is a bundle consisting of two services, specifically the Anti-Virus service and the Web-Content Filtering Firewall service. In this example, there is no existing bundle for the Basic Firewall and the Web-Content Filtering Firewall since this would be redundant.

The technical weighting for the Anti-Virus service, Basic Firewall service, Web-Content Filtering Firewall service were 70, 70, and 90, respectively. The business preference weighting for the Anti-Virus service, Basic Firewall service, Web-Content Filtering firewall services are 50, 60, and 70, respectively. The weighted summations are calculated for each service as described above. No thresholds are violated, so no alteration is required. The final scores for the five offerings are 35, 42, 63, 38.5, and 49, respectively. The comparison scores are obtained by dividing the individual service scores by two, to reflect the fact that the bundles are each composed of a maximum of two services (i.e., B=2). Thus, the comparison scores for the five offerings are 17.5, 21, 31.5, 38.5, and 49. Therefore, the offerings are ranked in reverse order in this case, according to the comparison scores, such that the best offering is offering number five, the bundle of Anti-Virus and Web-Content Filtering Firewall.

When the user elects to quit, the system returns to page 0 (not shown) the system's start-up state, in which the system is ready to begin the process at the initialization step. All accumulated results are saved to the IDB 210 for this user. Preferably the IDB 210 also saves associated helpful information such as record keeping information, billing information, or information useful for future inquiries (e.g., the number of levels or pages accessed, the cycle counter value which equals the number of cycles which occurred, the amount of time transpired, etc.).

In a preferred embodiment, the ranked offerings are provided by the servicer module 312 to the output module 314, along with the rankings, comparison scores, and offering descriptions. Alternatively, the psychological assistant module and special deals interface module provide information as well. The user utilizes the information to explain the offerings to the customer, starting with the highest ranked. The user is thus able to explain how the offering can help the customer avoid similar problems in the future, and the various other features and valuable advantages afforded by the service offering. Preferably, the user can sell one or more of the offered services/bundles to the customer since the offer will be highly relevant, organized and informative, and highly appropriate to this particular customer. Finally, the offered services and any resultant service sales can be stored in the IDB 210 for future reference with respect to this customer. In an alternative preferred embodiment, the information saved in the IDB 210 is saved at the conclusion of a previous step rather than at the inquiry conclusion. Interim saving of information is useful to, for example, improve operating efficiency, performance, or reliability when a user performs multiple back-to-back inquiries. In addition, interim saving of information is particularly helpful in the event of an unexpected malfunction or power loss.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The system provides a manner to simplify an otherwise complex process and increases the changes that the customer will recognize that they truly need an offered service and that the offered services performs the appropriate functions to protect the customer's network. It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for providing automatically facilitated marketing and provision of electronic services, comprising:
searching a database for a match between user input and information in the database;
obtaining keywords resulting from the searching step;
utilizing a database table to associate the keywords with potential services to sell to a customer; and
producing a set of suggested actual services and associated information regarding services that can be sold to the customer.

2. The method of claim 1, further comprising associating the keywords with generically-defined services.

3. The method of claim 1, further comprising calculating appropriate services to offer the customer utilizing a weighted summation of technical appropriateness values associated with at least one of generic, potential, actual or available services.

4. The method of claim 1, further comprising calculating preferential services to offer the customer utilizing a weighted summation of preference values associated with actual services offered by a service provider.

5. The method of claim 3, further comprising ranking potential generic services for presentment and comparison of preferential services.

6. The method of claim 4, further comprising ranking potential actual services for presentment and comparison of preferential services.

7. The method of claim 3, further comprising calculating maximum and minimum thresholds such that preferential services offered by a service provider do not override technical security decision criteria.

8. The method of claim 3, further comprising calculating ratio checks such that preferential services offered by a service provider do not override technical security decision criteria.

9. The method of claim 7, further comprising adjusting or reducing weighted summation values if the threshold is violated.

10. The method of claim 7, further comprising discarding a particular preferential service if the threshold or ratio check is violated.

11. The method of claim 7, further comprising calculating a comparison value by adjusting weighed summations for cases of service bundling.

12. The method of claim 1, further comprising outputting the suggested services and associated information to a user's processing device.

13. A computer-readable medium comprising:
logic configured to search a database for a match between user input and information in the database;
logic configured to obtain keywords resulting from the search;
logic configured to utilize a database table to associate the keywords with potential services to sell to a customer; and
logic configured to produce a set of suggested services and associated information of services that can be sold to customer.

14. The computer-readable medium of claim 13, further comprising logic configured to associate the keywords with generically-defined services.

15. The computer-readable medium of claim 13, further comprising logic configured to calculate appropriate services to offer the customer utilizing a weighted summation of technical appropriateness values associated with at least one of generic, potential, actual or available services.

16. The computer-readable medium of claim 13, further comprising logic configured to calculate preferential services to offer the customer utilizing a weighted summation of preference values associated with actual services by a service provider.

17. The computer-readable medium of claim 16, further comprising logic configured to rank potential services for presentment and comparison of preferential services.

18. The computer-readable medium of claim 16, further comprising logic configured to calculate maximum and minimum threshold such that preferential services offered by a service provider do not override technical security decision criteria.

19. The computer-readable medium of claim 18, further comprising logic configured to adjust or reduce weighted summation values if the threshold is violated.

20. The computer-readable medium of claim 18, further comprising logic configured to discard a particular preferential service if the threshold or ratio check is violated.

21. The computer readable medium of claim 18, further comprising logic configured to calculate a comparison value by adjusting weighed summations for cases of service bundling.

22. The computer-readable medium of claim 13, further comprising logic configured to output the suggested services and associated information to a user's processing device.

23. The computer-readable medium of claim 15, further comprising logic configured to rank potential generic services for presentment and comparison of preferential services.

24. A system for automatically facilitated marketing and provision of electronic security services, comprising:
a cycler configured to search through a plurality of databases to match user input with sales information in the databases and to provide keywords resulting from the search; and
a service suggestion analyzer operatively coupled to the cycler, the service suggestion analyzer configured to provide a set of potential services to be sold to a customer based on the keywords from the cycler.

25. The system of claim 24, wherein the service suggestion analyzer further comprises an analyzer module, a servicer module and an output module.

26. The system of claim 25, wherein the service suggestion analyzer further comprises a psychological assistant module and a special deals interface module.

27. The system of claim 25, wherein the analyzer module is further configured to produce a prioritized and clustered needs list that includes generic services.

28. The system of claim 27, wherein the analyzer module is further configured to include a lookup table to provide the clustered needs list.

29. The system of claim 27, wherein the analyzer module is further configured to perform technical weightings of potential services to prioritize the generic needs list.

30. The system of claim 25, wherein the servicer module is further configured to interface with the analyzer module to obtain the generic needs list and to produce a ranked set of suggested actual services offered by a service provider.

31. The system of claim 30, wherein the servicer module is further configured to incorporate stored preference weightings for an available offered service such that the set of suggested actual services are skewed towards services preferred to be sold by a service provider.

32. The system of claim 25, wherein the output module is operatively coupled to the servicer module and the output module is further configured to provide the ranked set of suggested actual services to a user via at least one of a user's display device of a processing device, auditory means including synthesized voice, email, or paging device.

33. The system of claim of claim 24, wherein the service suggestion analyzer is further configured to calculate appropriate services to offer the customer utilizing a weighted summation of technical appropriateness values associated with at least one of generic, potential, actual, or available services.

34. The system of claim 33, wherein the service suggestion analyzer is further configured to rank potential generic services for presentment and comparison of preferential services.

35. The system of claim 33, wherein the service suggestion analyzer is further configured to calculate ratio checks such that preferential services offered by a service provider do not override technical security decision criteria
